(19) United States
(12) Patent Application Publication
(10) Pub. No.: US 2026/0163831 A1
(43) Pub. Date: Jun. 11, 2026

(54) DETECTING NETWORK LOOPS USING CONTINUITY CHECK MESSAGE PACKETS FOR ALL SERVICES

(71) Applicant: Juniper Networks, Inc., Sunnyvale, CA (US)

(72) Inventors: Tarun KAWATRA, New Delhi (IN); Bharat M. GAONKAR, Bangalore (IN); Gowri Shankar RAMANARAYANAN, Bangalore (IN)

(21) Appl. No.: 19/389,854

(22) Filed: Nov. 14, 2025

(30) Foreign Application Priority Data
Dec. 9, 2024 (IN) 202441097057

(51) Int. Cl. H04L 43/12; H04L 47/62

(52) U.S. Cl. CPC H04L 43/12; H04L 47/6225

(57) ABSTRACT

A network device may generate continuity check message (CCM) packets for different services provided by a network, and may provide the CCM packets in a round robin fashion on a customer edge port of the network device. The network device may receive one or more of the CCM packets via the customer edge port, and may detect one or more loops associated with the one or more CCM packets based on receiving the one or more CCM packets. Alternatively, the network device may fail to receive one or more of the CCM packets via the customer edge port, and may determine that there are no loops based on failing to receive the one or more CCM packets.

### CROSS-REFERENCE TO RELATED APPLICATION

This Patent Application claims priority to Indian Provisional Patent Application No. 202441097057, filed on Dec. 9, 2024, and entitled “DETECTING NETWORK LOOPS USING CONTINUITY CHECK MESSAGE PACKETS FOR ALL SERVICES.” The disclosure of the prior Application is considered part of and is incorporated by reference into this Patent Application.

### BACKGROUND

Loops in an Ethernet virtual private network (EVPN) fabric may be caused by miswiring and/or misconfiguration of fabric components, or miswiring and/or misconfiguration of third party network devices to the EVPN fabric during deployment.

### SUMMARY

Some implementations described herein relate to a method. The method may include generating continuity check message (CCM) packets for different services provided by a network, and providing the CCM packets in a round robin fashion on a customer edge port of the network device. The method may include alternatively receiving one or more of the CCM packets via the customer edge port, or failing to receive one or more of the CCM packets via the customer edge port.

Some implementations described herein relate to a network device. The network device may include one or more memories and one or more processors. The one or more processors may be configured to generate CCM packets for different services provided by a network, wherein each of the CCM packets includes a chassis identifier, port information, and Ethernet segment identifier information provided in an organization-specific type-length-value. The one or more processors may be configured to provide the CCM packets in a round robin fashion on a customer edge port of the network device. The one or more processors may be configured to alternatively receive one or more of the CCM packets via the customer edge port, or fail to receive one or more of the CCM packets via the customer edge port.

Some implementations described herein relate to a non-transitory computer-readable medium that stores a set of instructions. The set of instructions, when executed by one or more processors of a network device, may cause the network device to generate CCM packets for different services provided by a network, wherein the CCM packets are multicast protocol data unit packets or frames. The set of instructions, when executed by one or more processors of the network device, may cause the network device to provide the CCM packets in a round robin fashion on a customer edge port of the network device. The set of instructions, when executed by one or more processors of the network device, may cause the network device to alternatively receive one or more of the CCM packets via the customer edge port, or fail to receive one or more of the CCM packets via the customer edge port.

### BRIEF DESCRIPTION OF THE DRAWINGS

FIGS. 1A-1E are diagrams of an example associated with detecting network loops using continuity check message (CCM) packets for all services.

FIG. 2 is a diagram of an example environment in which systems and/or methods described herein may be implemented.

FIGS. 3 and 4 are diagrams of example components of one or more devices of FIG. 2.

FIG. 5 is a flowchart of an example process for detecting network loops using CCM packets for all services.

### DETAILED DESCRIPTION

The following detailed description of example implementations refers to the accompanying drawings. The same reference numbers in different drawings may identify the same or similar elements.

Current loop detection techniques identify a loop only for a single configured service. However, the current loop detection techniques are unable to detect loops for multiple services. Thus, such techniques do not scale and are unable to identify loops for a different service other than the configured service. In a large fabric, where loops are formed toward a downstream at a provider edge (PE) network device to a customer edge (CE) network device, due to miswiring and/or misconfiguration, some of the loops are not detected through the control plane. During EVPN fabric deployment, identifying a cause of a loop, such as inaccurate wiring of fabric components or inaccurate wiring or misconfiguration of third party network devices to EVPN fabric devices (e.g., such as when connecting CE network devices), may be impossible with the current techniques. Thus, current techniques for detecting loops consume computing resources (e.g., processing resources, memory resources, communication resources, and/or the like), networking resources, and/or the like, associated with failing to detect loops for different services, failing to detect loops through the control plane, failing to identify causes of loops, handling customer complaints associated with undetected loops, handling lost traffic caused by undetected loops, and/or the like.

Some implementations described herein relate to a network device that detects network loops using CCM packets for all services. For example, the network device may generate CCM packets for different services, and may provide the CCM packets in a round robin fashion on a customer edge port of the network device. The network device may receive one or more of the CCM packets via the customer edge port, and may disable the customer edge port based on receiving the one or more CCM packets. The network device may detect one or more loops associated with the one or more CCM packets, and may determine whether the one or more loops are associated with all of the different services or a service of the different services. The network device may identify one or more causes for the one or more loops, and may provide the one or more causes for display to an operator. Alternatively, the network device may fail to receive one or more of the CCM packets via the customer edge port, may determine that there are no loops based on failing to receive the one or more CCM packets, and may provide an indication of no loops for display to the operator.

In this way, the network device detects network loops using CCM packets for all services. For example, the network device may detect loops for all services that are configured and may break Ethernet loops on a PE to CE port which is caused by misconfiguration of fabric components or misconfiguration of third party network devices to an EVPN fabric. The loop detection by the network device may utilize CCM protocol data units (PDUs) and may be independent of a state of EVPN signaling used to trigger traffic. The loop detection of the network device may be configured on PE to CE ports of the network device. The network device may periodically transmit CCM packets at level zero (0) for each of the services that are configured for the ports. Each CCM packet may include a chassis identifier (ID), port information, and Ethernet segment identifier (ESI) information provided in an organization-specific type-length-value (TLV). When a port receives CCM packets at level zero and containing the TLV, from the same network device or from a different network device on the same port or a different port, the network device may detect a loop and may disable the port or interface to cut the loop. Even if a loop is detected for just one service, the entire port or interface may be disabled. The network device may identify a peer network device (e.g., from which a CCM packet is received) using chassis information in the TLV. This may enable a network administrator or operator to identify which service has caused the loop. Thus, the network device conserves computing resources, networking resources, and/or the like that would otherwise have been consumed by failing to detect loops for different services, failing to detect loops through the control plane, failing to identify causes of loops, handling customer complaints associated with undetected loops, handling lost traffic caused by undetected loops, and/or the like.

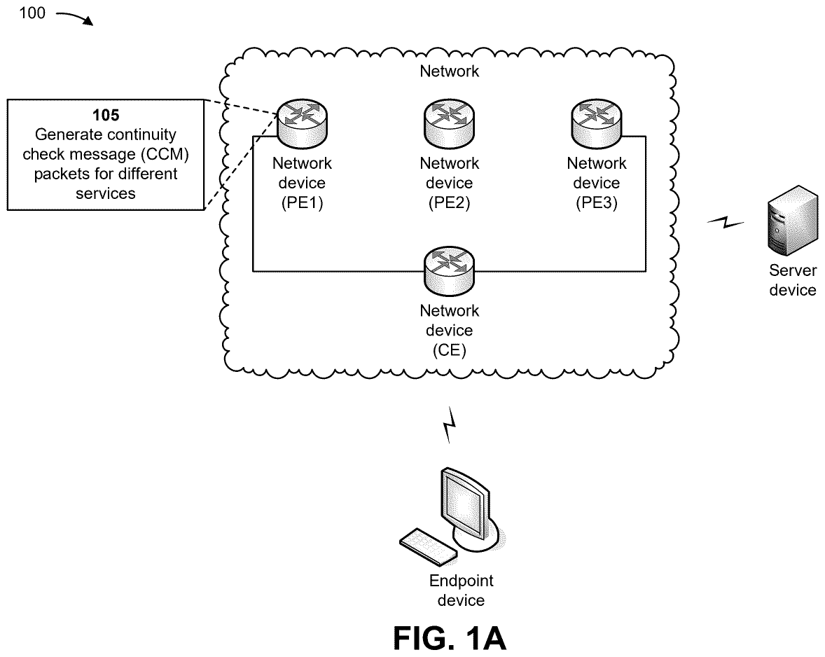

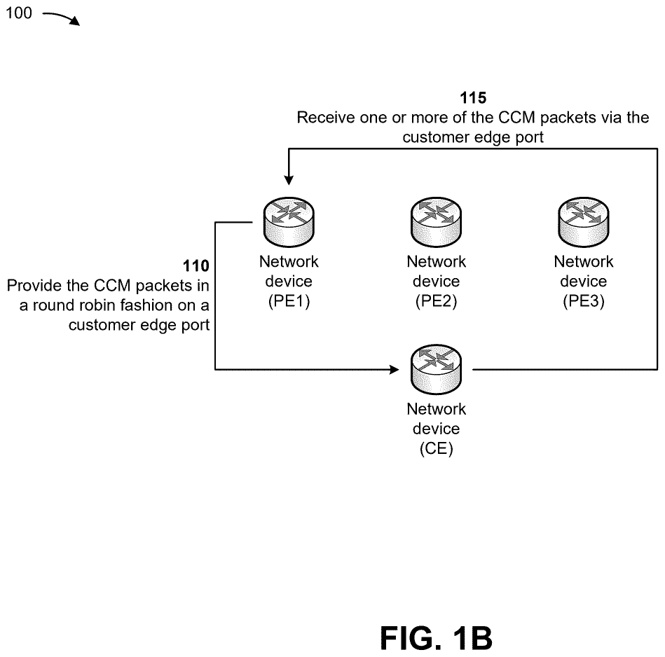

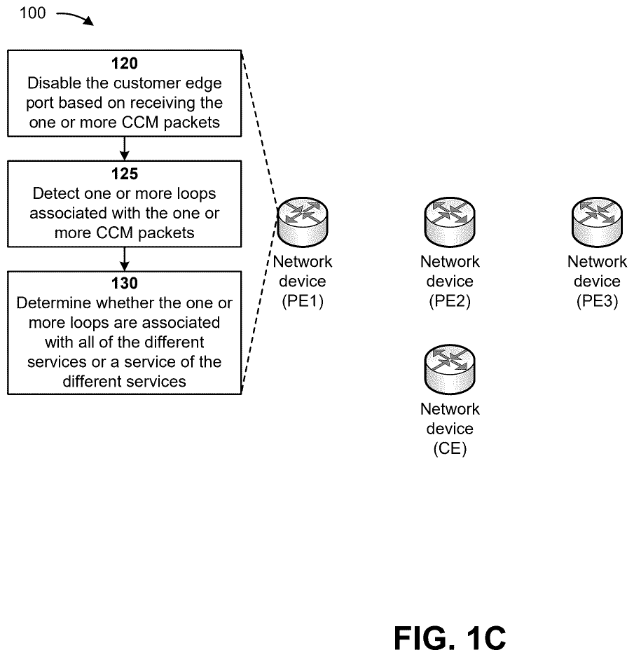

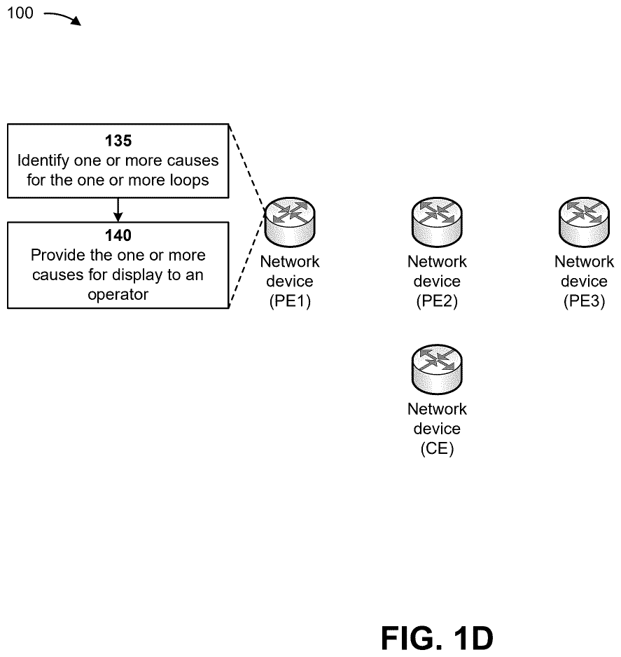

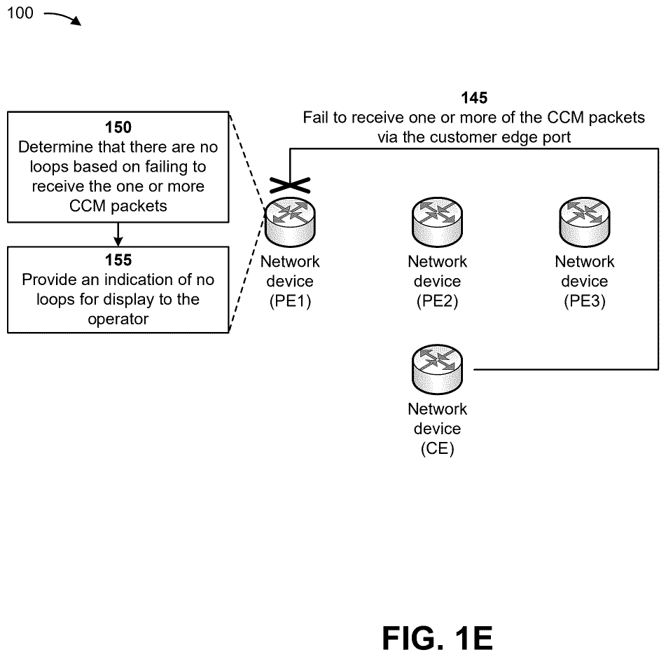

FIGS. 1A-1E are diagrams of an example 100 associated with detecting network loops using CCM packets for all services. As shown in FIGS. 1A-1E, the example 100 includes an endpoint device associated with a network and a server device. The network may include multiple network devices. The multiple network devices may include a first PE (PE1) network device, a second PE (PE2) network device, a third PE (PE3) network device, and a CE network device. Further details of the endpoint device, the server device, the network, and the network devices are provided elsewhere herein.

As shown in FIG. 1A, and by reference number 105, the network device (e.g., the first PE network device) may generate continuity check message (CCM) packets for different services provided by the network (e.g., an EVPN fabric). For example, in order to perform loop detection in the network, the network device may generate the CCM packets for the different services

provided by the network. Each of the CCM packets may include a chassis ID, port information, and ESI information provided in a TLV at level zero for each of the different services. In some implementations, the CCM packets may be multicast PDU packets or frames. The implementations may enhance the scale for loop detection by monitoring all virtual local area networks (VLANs) (e.g., services) configured for an interface (e.g., a customer edge port) of the network device.

As shown in FIG. 1B, and by reference number 110, the network device may provide the CCM packets in a round robin fashion on a customer edge port of the network device. For example, the network device may periodically transmit the CCM packets (e.g., the multicast PDU frames) on the customer edge port (e.g., a PE to CE port) of the network device. In some implementations, the network device may transmit the CCM packets (e.g., the loop detect PDUs) for different services in a round robin fashion. For example, the network device may transmit the CCM packets sequentially, one after another, on the customer edge port in a repeating order, ensuring that each configured service on the customer edge port is periodically checked for network loops. This round robin transmission allows for continuous monitoring of all services without favoring any single service. In one example, the network device may provide the CCM packets to the CE network device via the customer edge port.

As further shown in FIG. 1B, and by reference number 115, the network device may receive one or more of the CCM packets via the customer edge port. For example, the network device may receive one or more of the CCM packets via the customer edge port or may fail to receive one or more of the CCM packets via the customer edge port. In some implementations, when the one or more of the CCM packets are received via the customer edge port, the network device may trap the one or more of the CCM packets (e.g., the loop detect packets) via the customer edge port. This may trap the one or more CCM packets for all services configured on the customer edge port. For example, to trap the one or more packets for all services configured on the customer edge port, the network device may intercept and process the CCM packets as the CCM packets are received on the customer edge port, enabling the network device to detect and analyze potential network loops for each configured service.

As shown in FIG. 1C, and by reference number 120, the network device may disable the customer edge port based on receiving the one or more CCM packets. For example, when the one or more CCM packets are received on the customer edge port, the network device may disable the customer edge port for data traffic in order to cut one or more loops. The network device may not disable the customer edge port for the CCM packets. Thus, the network device may still receive and trap additional CCM packets on the customer edge port in order to detect one or more additional loops on the customer edge port.

As further shown in FIG. 1C, and by reference number 125, the network device may detect one or more loops associated with the one or more CCM packets. For example, receiving the one or more CCM packets on the customer edge port may indicate that one or more loops are associated with the one or more CCM packets. By receiving the CCM packets that were originally transmitted on the customer edge port, the network device may determine that the CCM packets have circulated back to the network device due to a loop in the network. Thus, the network device may detect the one or more loops based on receiving the one or more CCM packets via the customer edge port.

As further shown in FIG. 1C, and by reference number 130, the network device may determine whether the one or more loops are associated with all of the different services or a service of the different services. For example, the network device may determine that the one or more loops are associated with all of the different services. Alternatively, the network device may determine that the one or more loops are associated with a single service of the different services. In some implementations, if a network topology has a loop for all of the different services, then a CCM packet transmitted for a first service may be utilized by the network device to identify and report the loop. Alternatively, if there is a loop only for a specific service, the network device may detect the loop when the CCM packet for the specific service is transmitted and received via the customer edge port of the network device.

As shown in FIG. 1D, and by reference number 135, the network device may identify one or more causes for the one or more loops. For example, the network device may utilize information included in TLVs of the one or more CCM packets to identify the one or more causes for the one or more loops. The network device may identify peer network devices (e.g., from which the one or more CCM packets are received) using chassis information in the TLVs. The one or more causes may include inaccurate wiring of fabric components, inaccurate wiring or misconfiguration of third party network devices to EVPN fabric devices, and/or the like.

As further shown in FIG. 1D, and by reference number 140, the network device may provide the one or more causes for display to an operator. For example, the network device may provide the one or more causes for display to the operator via a command line interface (CLI) of the network device. Alternatively, or additionally, the network device may provide information identifying the one or more causes to a user device of the operator, and the user device may display the information identifying the one or more causes to the operator.

As shown in FIG. 1E, and by reference number 145, the network device may fail to receive one or more of the CCM packets via the customer edge port. For example, when there are no loops associated with the network and the different services, the network device may not receive the one or more CCM packets via the customer edge port. Rather, the CCM packets do not return to the customer edge port of the network device and continue along their intended path without circulating back.

As further shown in FIG. 1E, and by reference number 150, the network device may determine that there are no loops based on failing to receive the one or more CCM packets. For example, when the one or more CCM packets are not received via the customer edge port, the network device may determine that there are no loops associated with the network and the different services. This absence of returned CCM packets may indicate a healthy network configuration for the monitored services.

As further shown in FIG. 1E, and by reference number 155, the network device may provide an indication of no loops for display to the operator. For example, the network device may provide the indication of no loops for display to the operator via the CLI of the network device. Alternatively, or additionally, the network device may provide the indication of no loops to a user device of the operator, and the user device may display the indication of no loops to the operator.

Thus, the network may provide considerable advantages during provisioning since no data traffic needs to be generated explicitly during provisioning. A loop detect configuration may enable the network device to generate the CCM packets that may be utilized to identify any service or wiring misconfiguration that is causing a loop. If any CCM packets are received from the network device itself or from another network device in the EVPN fabric, the network device may identify a loop and may disable the customer edge port.

In this way, the network device detects network loops using CCM packets for all services. For example, the network device may detect loops for all services that are configured and break Ethernet loops on a PE to CE port which is caused by misconfiguration of fabric components or misconfiguration of third party network devices to an EVPN fabric. The loop detection by the network device may utilize CCM PDUs and may be independent of a state of EVPN signaling used to trigger traffic. The loop detection of the network device may be configured on PE to CE ports of the network device. The network device may periodically transmit CCM packets that each include a chassis ID, port information, and ESI information provided in a TLV and at level zero for each of the services that are configured for the ports. When a port receives CCM packets at level zero and containing the TLV, from either the same interface or from another interface, the network device may detect a loop and may disable the interface to cut the loop. Even if a loop is detected for just one service, the entire interface may be disabled. The network device may identify a peer network device (e.g., from which a CCM packet is received) using chassis information in the TLV. This may enable a network administrator or operator to identify which service has caused the loop. Thus, the network device conserves computing resources, networking resources, and/or the like that would otherwise have been consumed by failing to detect loops for different services, failing to detect loops through the control plane, failing to identify causes of loops, handling customer complaints associated with undetected loops, handling lost traffic caused by undetected loops, and/or the like.

As indicated above, FIGS. 1A-1E are provided as an example. Other examples may differ from what is described with regard to FIGS. 1A-1E. The number and arrangement of devices shown in FIGS. 1A-1E are provided as an example. In practice, there may be additional devices, fewer devices, different devices, or differently arranged devices than those shown in FIGS. 1A-1E. Furthermore, two or more devices shown in FIGS. 1A-1E may be implemented within a single device, or a single device shown in FIGS. 1A-1E may be implemented as multiple, distributed devices. Additionally, or alternatively, a set of devices (e.g., one or more devices) shown in FIGS. 1A-1E may perform one or more functions described as being performed by another set of devices shown in FIGS. 1A-1E.

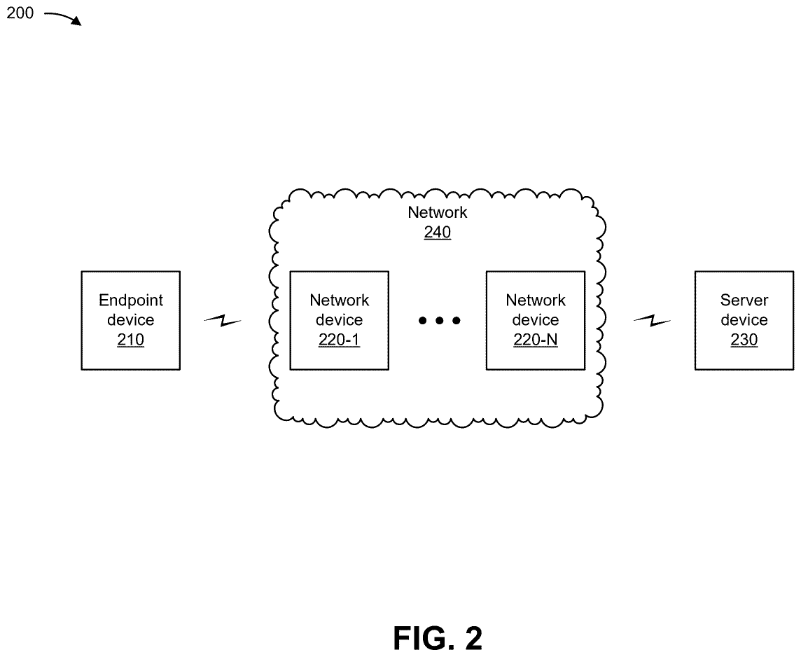

FIG. 2 is a diagram of an example environment 200 in which systems and/or methods described herein may be implemented. As shown in FIG. 2, environment 200 may include an endpoint device 210, a group of network devices 220 (shown as network device 220-1 through network device 220-N), a server device 230, and a network 240. Devices of the environment 200 may interconnect via wired connections, wireless connections, or a combination of wired and wireless connections.

The endpoint device 210 includes one or more devices capable of receiving, generating, storing, processing, and/or providing information, such as information described herein. For example, the endpoint device 210 may include a mobile phone (e.g., a smart phone or a radiotelephone), a laptop computer, a tablet computer, a desktop computer, a handheld computer, a gaming device, a wearable communication device (e.g., a smart watch, a pair of smart glasses, a heart rate monitor, a fitness tracker, smart clothing, smart jewelry, or a head mounted display), a network device, a server device, a group of server devices, or a similar type of device. In some implementations, the endpoint device 210 may receive network traffic from and/or may provide network traffic to other endpoint devices 210 and/or the server device 230, via the network 240 (e.g., by routing packets using the network devices 220 as intermediaries).

The network device 220 includes one or more devices capable of receiving, processing, storing, routing, and/or providing traffic (e.g., a packet or other information or metadata) in a manner described herein. For example, the network device 220 may include a router, such as a label switching router (LSR), a label edge router (LER), an ingress router, an egress router, a provider router (e.g., a provider edge router or a provider core router), a virtual router, a route reflector, an area border router, or another type of router. Additionally, or alternatively, the network device 220 may include a gateway, a switch, a firewall, a hub, a bridge, a reverse proxy, a server (e.g., a proxy server, a cloud server, or a data center server), a load balancer, and/or a similar device. In some implementations, the network device 220 may be a physical device implemented within a housing, such as a chassis. In some implementations, the network device 220 may be a virtual device implemented by one or more computer devices of a cloud computing environment or a data center. In some implementations, a group of network devices 220 may be a group of data center nodes that are used to route traffic flow through the network 240.

The server device 230 may include one or more devices capable of receiving, generating, storing, processing, providing, and/or routing information, as described elsewhere herein. The server device 230 may include a communication device and/or a computing device. For example, the server device 230 may include a server, such as an application server, a client server, a web server, a database server, a host server, a proxy server, a virtual server (e.g., executing on computing hardware), or a server in a cloud computing system. In some implementations, the server device 230 may include computing hardware used in a cloud computing environment.

The network 240 includes one or more wired and/or wireless networks. For example, the network 240 may include a packet switched network, a cellular network (e.g., a fifth generation (5G) network, a fourth generation (4G) network, such as a long-term evolution (LTE) network, a third generation (3G) network, and/or a code division multiple access (CDMA) network), a public land mobile network (PLMN), a local area network (LAN), a WAN, a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the environment 200 may perform one or more functions described as being performed by another set of devices of the environment 200.

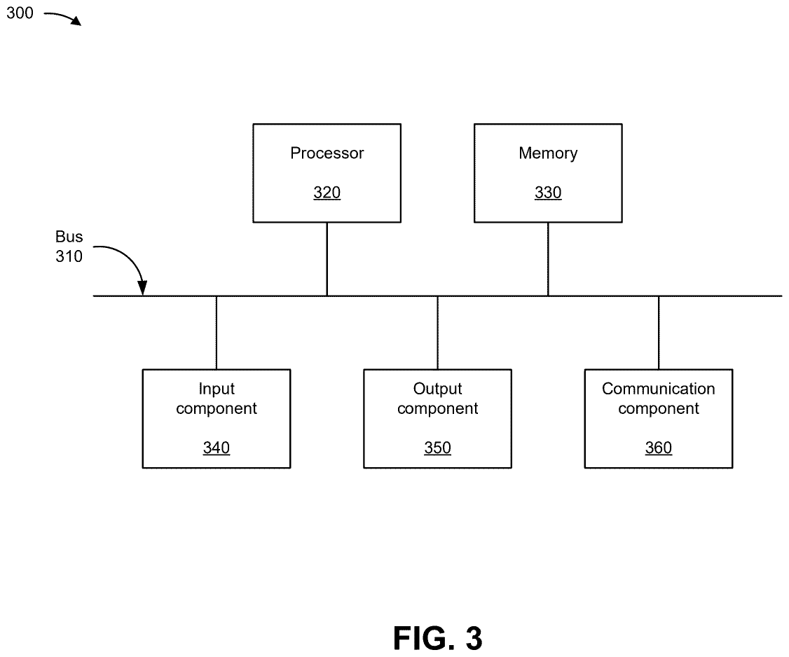

FIG. 3 is a diagram of example components of one or more devices of FIG. 2. The example components may be included in a device 300, which may correspond to the endpoint device 210, the network device 220, and/or the server device 230. In some implementations, the endpoint device 210, the network device 220, and/or the server device 230 may include one or more devices 300 and/or one or more components of the device 300. As shown in FIG. 3, the device 300 may include a bus 310, a processor 320, a memory 330, an input component 340, an output component 350, and a communication component 360.

The bus 310 includes one or more components that enable wired and/or wireless communication among the components of the device 300. The bus 310 may couple together two or more components of FIG. 3, such as via operative coupling, communicative coupling, electronic coupling, and/or electric coupling. The processor 320 includes a central processing unit (CPU), a graphics processing unit (GPU), an accelerated processing unit (APU), a microprocessor, a controller, a microcontroller, a digital signal processor (DSP), a field-programmable gate array (FPGA), an application-specific integrated circuit (ASIC), and/or another type of processing component. The processor 320 is implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 stores information, instructions, and/or software (e.g., one or more software applications) related to the operation of the device 300. In some implementations, the memory 330 includes one or more memories that are coupled to one or more processors (e.g., the processor 320), such as via the bus 310.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., the memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

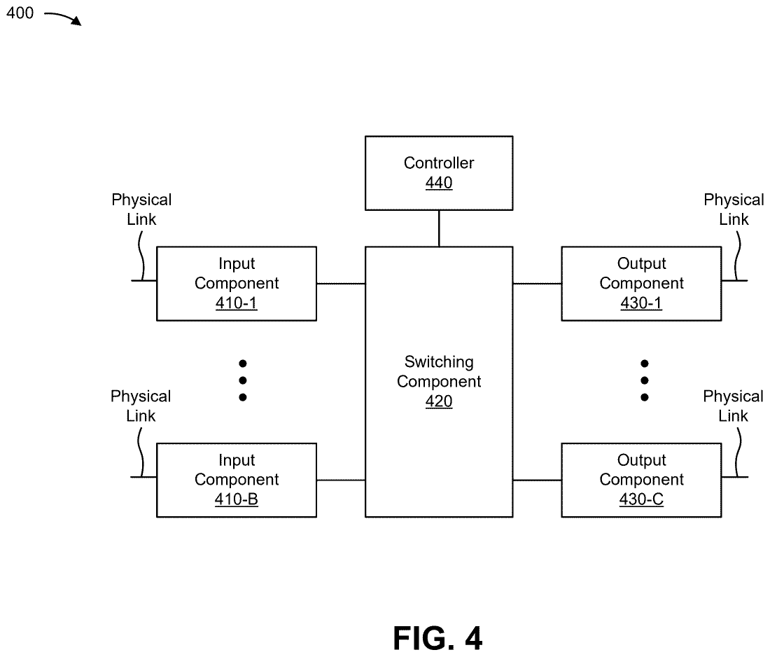

FIG. 4 is a diagram of example components of one or more devices of FIG. 2. The example components may be included in a device 400. The device 400 may correspond to the network device 220. In some implementations, the network device 220 may include one or more devices 400 and/or one or more components of the device 400. As shown in FIG. 4, the device 400 may include one or more input components 410-1 through 410-B (B≥1) (hereinafter referred to collectively as input components 410, and individually as input component 410), a switching component 420, one or more output components 430-1 through 430-C (C≥1) (hereinafter referred to collectively as output components 430, and individually as output component 430), and a controller 440.

The input component 410 may be one or more points of attachment for physical links and may be one or more points of entry for incoming traffic, such as packets. The input component 410 may process incoming traffic, such as by performing data link layer encapsulation or decapsulation. In some implementations, the input component 410 may transmit and/or receive packets. In some implementations, the input component 410 may include an input line card that includes one or more packet processing components (e.g., in the form of integrated circuits), such as one or more interface cards (IFCs), packet forwarding components, line card controller components, input ports, processors, memories, and/or input queues. In some implementations, the device 400 may include one or more input components 410.

The switching component 420 may interconnect the input components 410 with the output components 430. In some implementations, the switching component 420 may be implemented via one or more crossbars, via busses, and/or with shared memories. The shared memories may act as temporary buffers to store packets from the input components 410 before the packets are eventually scheduled for delivery to the output components 430. In some implementations, the switching component 420 may enable the input components 410, the output components 430, and/or the controller 440 to communicate with one another.

The output component 430 may store packets and may schedule packets for transmission on output physical links. The output component 430 may support data link layer encapsulation or decapsulation, and/or a variety of higher-level protocols. In some implementations, the output component 430 may transmit packets and/or receive packets. In some implementations, the output component 430 may include an output line card that includes one or more packet processing components (e.g., in the form of integrated circuits), such as one or more IFCs, packet forwarding components, line card controller components, output ports, processors, memories, and/or output queues. In some implementations, the device 400 may include one or more output components 430. In some implementations, the input component 410 and the output component 430 may be implemented by the same set of components (e.g., and input/output component may be a combination of the input component 410 and the output component 430).

The controller 440 includes a processor in the form of, for example, a CPU, a GPU, an APU, a microprocessor, a microcontroller, a DSP, an FPGA, an ASIC, and/or another type of processor. The processor is implemented in hardware, firmware, or a combination of hardware and software. In some implementations, the controller 440 may include one or more processors that can be programmed to perform a function.

In some implementations, the controller 440 may include a RAM, a ROM, and/or another type of dynamic or static storage device (e.g., a flash memory, a magnetic memory, an optical memory, etc.) that stores information and/or instructions for use by the controller 440.

In some implementations, the controller 440 may communicate with other devices, networks, and/or systems connected to the device 400 to exchange information regarding network topology. The controller 440 may create routing tables based on the network topology information, may create forwarding tables based on the routing tables, and may forward the forwarding tables to the input components 410 and/or output components 430. The input components 410 and/or the output components 430 may use the forwarding tables to perform route lookups for incoming and/or outgoing packets.

The controller 440 may perform one or more processes described herein. The controller 440 may perform these processes in response to executing software instructions stored by a non-transitory computer-readable medium. A computer-readable medium is defined herein as a non-transitory memory device. A memory device includes memory space within a single physical storage device or memory space spread across multiple physical storage devices.

Software instructions may be read into a memory and/or storage component associated with the controller 440 from another computer-readable medium or from another device via a communication component. When executed, software instructions stored in a memory and/or storage component associated with the controller 440 may cause the controller 440 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 4 are provided as an example. In practice, the device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

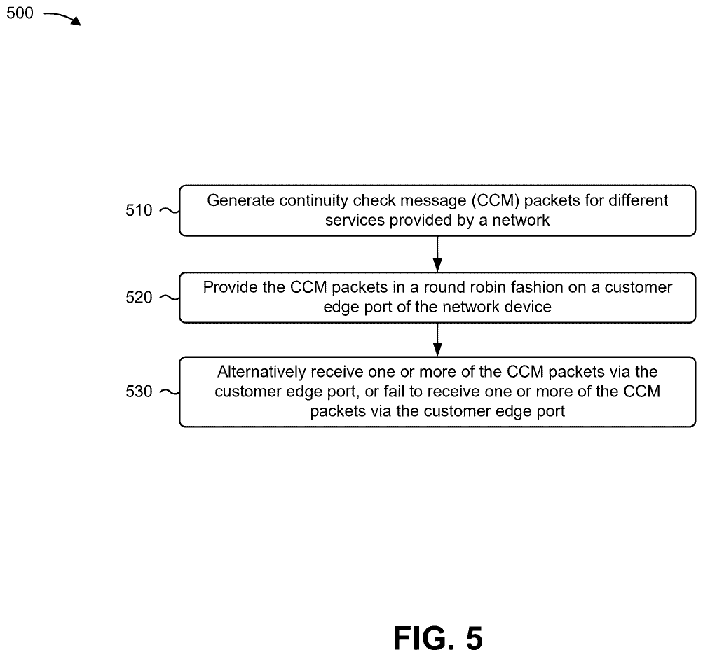

FIG. 5 is a flowchart of an example process 500 for detecting network loops using CCM packets for all services. In some implementations, one or more process blocks of FIG. 5 may be performed by a network device (e.g., the network device 220). In some implementations, one or more process blocks of FIG. 5 may be performed by another device or a group of devices separate from or including the network device, such as an endpoint device (e.g., the endpoint device 210) and/or a server device (e.g., the server device 230). Additionally, or alternatively, one or more process blocks of FIG. 5 may be performed by one or more components of the device 300, such as the processor 320, the memory 330, the input component 340, the output component 350, and/or the communication component 360. Additionally, or alternatively, one or more process blocks of FIG. 5 may be performed by one or more components of the device 400, such as the input component 410, the switching component 420, the output component 430, and/or the controller 440.

As shown in FIG. 5, process 500 may include generating CCM packets for different services provided by a network (block 510). For example, the network device may generate CCM packets for different services provided by a network, as described above. In some implementations, each of the CCM packets includes a chassis identifier, port information, and Ethernet segment identifier information provided in an organization-specific type-length-value. In some implementations, the CCM packets are multicast protocol data unit packets or frames. In some implementations, the network device is a provider edge network device. In some implementations, the network is an Ethernet virtual private network fabric.

As further shown in FIG. 5, process 500 may include providing the CCM packets in a round robin fashion on a customer edge port of the network device (block 520). For example, the network device may provide the CCM packets in a round robin fashion on a customer edge port of the network device, as described above.

As further shown in FIG. 5, process 500 may include alternatively receiving one or more of the CCM packets via the customer edge port, or failing to receive one or more of the CCM packets via the customer edge port (block 530). For example, the network device may alternatively receive one or more of the CCM packets via the customer edge port, or fail to receive one or more of the CCM packets via the customer edge port, as described above.

In some implementations, process 500 includes disabling the customer edge port based on receiving the one or more CCM packets, and detecting one or more loops associated with the one or more CCM packets based on receiving the one or more CCM packets. In some implementations, disabling the customer edge port comprises disabling the customer edge port for data traffic.

In some implementations, process 500 includes determining whether the one or more loops are associated with all of the different services or a service of the different services. In some implementations, process 500 includes identifying one or more causes for the one or more loops, and providing the one or more causes for display. In some implementations, the one or more causes include at least one of inaccurate wiring of fabric components or inaccurate wiring or misconfiguration of third party network devices to an Ethernet virtual private network fabric device.

In some implementations, process 500 includes determining that there are no loops based on failing to receive the one or more CCM packets. In some implementations, process 500 includes providing an indication of no loops for display. In some implementations, process 500 includes trapping the one or more of the CCM packets for all services configured on the customer edge port based on receiving the one or more CCM packets via the customer edge port.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

The foregoing disclosure provides illustration and description but is not intended to be exhaustive or to limit the implementations to the precise form disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
generating, by a network device, continuity check message (CCM) packets for different services provided by a network;
providing, by the network device, the CCM packets in a round robin fashion on a customer edge port of the network device; and
alternatively:
receiving, by the network device, one or more of the CCM packets via the customer edge port, or
failing to receive, by the network device, one or more of the CCM packets via the customer edge port.

2. The method of claim 1, further comprising:
disabling the customer edge port based on receiving the one or more CCM packets; and
detecting one or more loops associated with the one or more CCM packets based on receiving the one or more CCM packets.

3. The method of claim 2, wherein disabling the customer edge port comprises:
disabling the customer edge port for data traffic.

4. The method of claim 2, further comprising:
determining whether the one or more loops are associated with all of the different services or a service of the different services.

5. The method of claim 2, further comprising:
identifying one or more causes for the one or more loops; and
providing the one or more causes for display.

6. The method of claim 5, wherein the one or more causes include at least one of inaccurate wiring of fabric components or inaccurate wiring or misconfiguration of third party network devices to an Ethernet virtual private network fabric device.

7. The method of claim 1, wherein each of the CCM packets includes a chassis identifier, port information, and Ethernet segment identifier information provided in an organization-specific type-length-value.

8. A network device, comprising:
one or more memories; and
one or more processors to:
generate continuity check message (CCM) packets for different services provided by a network, wherein each of the CCM packets includes a chassis identifier, port information, and Ethernet segment identifier information provided in an organization-specific type-length-value;
provide the CCM packets in a round robin fashion on a customer edge port of the network device; and
alternatively:
receive one or more of the CCM packets via the customer edge port, or
fail to receive one or more of the CCM packets via the customer edge port.

9. The network device of claim 8, wherein the CCM packets are multicast protocol data unit packets or frames.

10. The network device of claim 8, wherein the one or more processors are further to:
determine that there are no loops based on failing to receive the one or more CCM packets.

11. The network device of claim 10, wherein the one or more processors are further to:
provide an indication of no loops for display.

12. The network device of claim 8, wherein the one or more processors are further to:
trap the one or more of the CCM packets for all services configured on the customer edge port based on receiving the one or more CCM packets via the customer edge port.

13. The network device of claim 8, wherein the network device is a provider edge network device.

14. The network device of claim 8, wherein the network is an Ethernet virtual private network fabric.

15. A non-transitory computer-readable medium storing a set of instructions, the set of instructions comprising:
one or more instructions that, when executed by one or more processors of a network device, cause the network device to:
generate continuity check message (CCM) packets for different services provided by a network, wherein the CCM packets are multicast protocol data unit packets or frames;
provide the CCM packets in a round robin fashion on a customer edge port of the network device; and
alternatively:
receive one or more of the CCM packets via the customer edge port, or
fail to receive one or more of the CCM packets via the customer edge port.

16. The non-transitory computer-readable medium of claim 15, wherein the one or more instructions further cause the network device to:
disable the customer edge port based on receiving the one or more CCM packets; and
detect one or more loops associated with the one or more CCM packets based on receiving the one or more CCM packets.

17. The non-transitory computer-readable medium of claim 16, wherein the one or more instructions further cause the network device to:
determine whether the one or more loops are associated with all of the different services or a service of the different services.

18. The non-transitory computer-readable medium of claim 16, wherein the one or more instructions further cause the network device to:
identify one or more causes for the one or more loops; and
provide the one or more causes for display.

19. The non-transitory computer-readable medium of claim 15, wherein the one or more instructions further cause the network device to:
determine that there are no loops based on failing to receive the one or more CCM packets.

20. The non-transitory computer-readable medium of claim 19, wherein the one or more instructions further cause the network device to:
provide an indication of no loops for display.
